(19) United States
(12) Patent Application Publication
(10) Pub. No.: US 2009/0320058 A1
(43) Pub. Date: Dec. 24, 2009

(54) Multimedia Content Distribution System and Method for Multiple Dwelling Unit

(75) Inventors: Keith Reynolds Wehmeyer, Fishers, IN (US); Terry Wayne Lockridge, Dayton, IN (US); Mike Arthur Derrenberger, Valencia, CA (US)

Correspondence Address: Robert D. Shedd, Patent Operations;THOMSON Licensing LLC, P.O. Box 5312, Princeton, NJ, 08543-5312, US

(73) Assignee: Thomson Licensing, Boulogne-Billancourt (FR)

(21) Appl. No.: 11/887,610

(22) PCT Filed: Dec. 6, 2005
(86) PCT No.: PCT/US2005/044102

§ 371 Date: Oct. 1, 2007

Related U.S. Application Data
(60) Provisional application No. 60/668,377, filed on Apr. 5, 2005.

(51) Int. Cl. H04N 7/167; H04N 7/18; H04N 7/20

(52) U.S. Cl. 725/31; 725/78; 725/63

(57) ABSTRACT

A method for distributing video programs in a multiple dwelling unit from a receiver device associated with the unit to a plurality of client devices located in the multiple dwelling unit, including: receiving a plurality of video programs associated with a plurality of television channels from a signal source; receiving a request for a particular video program associated with a particular television channel from a selected one of the plurality of client devices; confirming that an account associated with the selected client device is authorized to receive the particular video program on the particular television channel; descrambling the particular video program using account data associated with the selected client device in response to the confirmation; scrambling the descrambled particular video program using a local key associated with the selected client device and transmitting the re-scrambled video program to the selected client device; and maintaining account data associated with each of the client devices in the receiver and transmitting updated account data to the signal source.

### FIELD OF THE INVENTION

This invention relates to the field of broadcast programming reception systems, and, more particularly, to subscription based broadcast programming reception and distribution to multiple dwelling units.

### BACKGROUND OF THE INVENTION

Subscription based broadcast program distribution for multiple dwelling unit facilities such as hotels, apartment complexes and university campuses, may be analogized to multiple implementations of reception systems for single dwelling units, such as single family homes. The present invention will be discussed as it relates to satellite television broadcast reception systems, such as DIRECTV™-based Digital Broadcast Systems (DBSs). It should be understood however, that the present invention has applicability to a wide range of broadcast distribution systems, such as cable television systems and distribution systems that utilize the global interconnection of computers and computer networks commonly referred to as the Internet.

Generally, a satellite television system includes an antenna (including a dish), a low noise block down-converter (LNB), a satellite receiver (set-top box) and a television set (TV). The satellite receiver allows a user to tune a desired channel for viewing, and is normally connected to the TV directly. Conventionally, if another user wants another TV with independent channel control, that user needs to employ a separate set-top box in conjunction with that TV.

It is common to provide restricted content via a satellite television system, a non-limiting example being pay-per-view (PPV) access programming. To provide access to such programming, a conditional access (CA) module is conventionally supplied with each receiver. However, due to the distributed nature of the receivers, CA modules themselves may be relatively unsecured. This is particularly problematic in hotel accommodations, where it is believed the theft of CA modules from receivers is common.

Also, to provide satellite service to several units in multiple dwelling units, separate satellite receiver boxes are conventionally used with each TV. In addition to the cost of buying additional satellite receivers, each additional satellite receiver is generally placed in a different dwelling unit. As such, each dwelling unit typically requires a telephone jack for providing a telephone callback link for the set-top box housed therein. As is understood by those possessing an ordinary skill in the pertinent arts, a callback link is provided to communicate billing or other information from a satellite receiver to a video source. Where billing data is temporarily stored at the distributed locations, there is a risk that communication with one or more of the local set-top boxes will be interrupted, resulting in the billing information not being timely reported to the broadcast source. This leads to lost revenue for the broadcast provider.

Accordingly, it is believed to be desirable to provide a multiple dwelling unit multimedia content distribution system and method that provides for centralized billing information collection and provision to a service provider, as well as security for CA modules themselves.

### SUMMARY OF THE INVENTION

A method for distributing video programs in a multiple dwelling unit from a receiver device associated with the unit to a plurality of client devices located in the multiple dwelling unit, including: receiving a plurality of video programs associated with a plurality of television channels from a signal source; receiving a request for a particular video program associated with a particular television channel from a selected one of the plurality of client devices; confirming that an account associated with the selected client device is authorized to receive the particular video program on the particular television channel; descrambling the particular video program using account data associated with the selected client device in response to the confirmation; re-scrambling the descrambled particular video program using a local key associated with the selected client device and transmitting the re-scrambled video program to the selected client device; and maintaining account data associated with each of the client devices in the receiver and transmitting updated account data to the signal source.

### BRIEF DESCRIPTION OF THE DRAWINGS

Understanding of the present invention will be facilitated by considering the following detailed description of the preferred embodiments of the present invention taken in conjunction with the accompanying drawings, in which like numerals refer to like parts, and:

FIG. 1 illustrates a block diagram of a system according to an aspect of the present invention;

FIG. 2 illustrates a block diagram of a receiver according to an aspect of the present invention;

FIG. 3 illustrates a flow diagram of a process according to an aspect of the present invention; and,

FIG. 4 illustrates a block diagram of a client device according to an aspect of the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in typical subscription based broadcast, reception and presentation systems and methods. Those of ordinary skill in the art may recognize that other elements and/or steps are desirable and/or required in implementing the present invention. However, because such elements and steps are well known in the art, a detailed discussion of such elements and steps is not provided herein.

According to an aspect of the present invention, a video head-end offloads the conditional access and PPV billing functions of the various video set-top boxes in a multiple dwelling unit structure. “Video head-end”, as used herein, generally refers to a control center of a subscription based programming delivery system, where broadcast signals are received and distributed to multiple dwelling units. In such a configuration, the video head-end tunes to the desired transponder(s), de-multiplexes the program stream(s), and delivers the program streams to individual client devices (e.g., set-top boxes) located in the dwelling units. By essentially re-locating the conditional access modules to the head-end, CA module theft may be prevented by securing the head-end (e.g., in a wiring closet).

The head-end may utilize conventional copy protection mechanisms to ensure that content indicative signals it delivers to the client devices are not “in the clear” over the transmission medium, which may take the form of Category 5 (Cat5) wiring or QAM-based Ethernet, for example. Candidate copy protection schemes include SmartRight, which is commercially available from the assignee hereof, Thomson Multimedia, and IPsec implementations. For non-limiting purposes of explanation, IPsec (short for IP security) is a set of protocols developed by the Internet Engineering Task Force (IETF) to support secure exchange of packets at the Internet Protocol (IP) layer. IPsec has been conventionally deployed to implement Virtual Private Networks (VPNs). IPsec supports two encryption modes: transport and tunnel. Transport mode encrypts only the data portion (payload) of each packet, but leaves the header untouched. The more secure tunnel mode encrypts both the header and the payload. On the receiving side, an IPsec-compliant device decrypts each packet. Either the transport or tunnel mode may be used with the content distribution system and method of the present invention.

According to an aspect of the present invention, each client device communicates programming, such as pay-per-view (PPV) requests to the head-end, which authorizes the transaction and sends the requested program to the requesting client device. The head-end aggregates purchases from the client devices, and communicates with a service provider, such as DIRECTV™, via a callback link, in a same manner as conventional individual set-top boxes. However, the head-end sends aggregated program billing information for the multiple dwellings, e.g., multiple service provider accounts, to the service provider for processing. As will be readily ascertained, this permits easier billing for the service provider and eliminates the need for each dwelling unit housed client device to be connected to a separate callback link, such as a phone line.

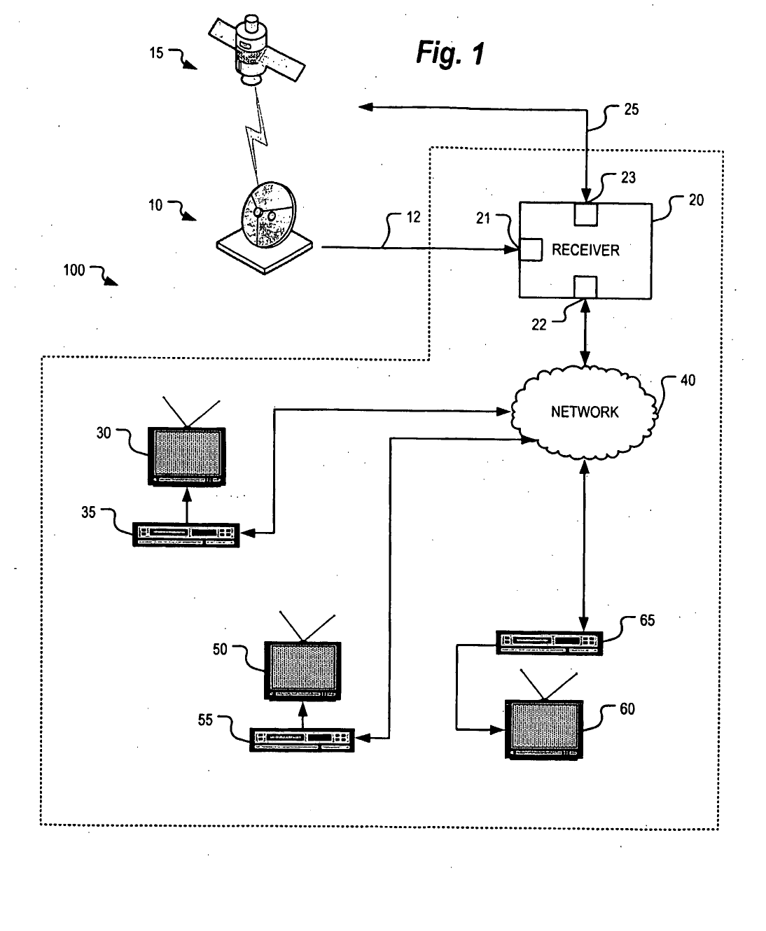

Referring now to FIG. 1, there is shown a block diagram of a system 100 according to an aspect of the present invention. System 100 includes an antenna 10 for receiving broadcast video program signals from a broadcast source 15, and a receiver 20 for selectively distributing the received signals to televisions 30, 50, 60. It should be understood that while three televisions are shown, the actual number of televisions may vary widely, and a substantially greater number of televisions and dwelling units may be supported. In the case of a broadcast source including a satellite 15, antenna 10 normally includes a dish and a feedhorn for receiving the satellite video signals, and a low noise block (LNB) for amplifying the received satellite video signals and translating all of the satellite's carrier frequencies to a first IF frequency (intermediate frequency), usually about 950 to 1450 MHz (megahertz) in the L band. This down conversion of satellite carrier frequencies permits connection from the antenna 10 and the satellite receiver to be made through a coaxial cable 12, rather than a waveguide, which is expensive. The feedhorn and the LNB are not shown in the figure.

Each television 30, 50, 60 is associated with a remote control (not shown) for sending a wireless remote control signal including channel selection information to satellite receiver 20, which tunes to the specified channel for that television. Satellite receiver 20 can tune to a different channel for each television, so that each television can display a different program simultaneously. Upon receiving the broadcast video signals at an input terminal, or port, 21 from the antenna 10, the satellite receiver 20 tunes to channels in response to respective remote control signals, and provides the video signals from the respective channels to televisions 30, 50, 60 via port 22.

Each television 30, 50, 60 may be, but is not limited to, a display supporting HDTV (High Definition Television) formats and/or SDTV (Standard Definition Television) formats. Each television 30, 50, 60 is communicatively coupled to an associated client device 35, 55, 65, which is in-turn coupled to receiver 20 via communications network 40. Devices 35, 55, 65 may be communicatively coupled to televisions 30, 50, 60 via conventional coaxial cables, component connections and/or digital links, e.g., high density multimedia input (HDMI) connections, respectively.

Network 40 may take the form of a data network, such as wireless and/or wired network, e.g., a user datagram protocol (UDP) compliant network, such as a TCP/IP network. Where a wireless network 40 is used (e.g., an 802.11x compliant network), receiver 20 may optionally include a transceiver, such as a radio frequency (RF) transmitter, receiver and antenna. Alternatively, a separate wireless network interface may be used and be communicatively coupled to receiver 20. In either case, satellite receiver 20 and client devices 35, 55, 65 communicate through network 40, and satellite receiver 20 converts the tuned video signals into packets having network 40 addresses of the network clients 35, 45, 55, which may be wireless or wired, as destination addresses so that received content is provided to televisions 30, 50, 60.

For billing and other administrative purposes associated with each client 35, 45 and 55, satellite receiver 20 also includes a callback link 25 port 23. Callback link 25 may take the form of a plain old telephone system (POTS) link to the service provider, so that a user can, for example, purchase PPV programming. This callback link may be shared by all televisions 30, 50, 60, operate responsively to user interaction with device 35, 55, 65 devices, and operate dependently upon user accounts associated with these devices. Accordingly, multiple callback data streams from individual devices 35, 55, 65 corresponding to different user accounts with a service provider may be aggregated and transmitted using a same callback link. Advantageously, this allows a system 100 operator to store billing information at a secure location, e.g., at receiver 20, rather than within each device 35, 55, 65. In this way, should any of devices 35, 55, 65 be individually disconnected, prior billing information (that may correspond to purchased PPV events) that has not yet been transmitted to the broadcast provider is not lost or delayed.

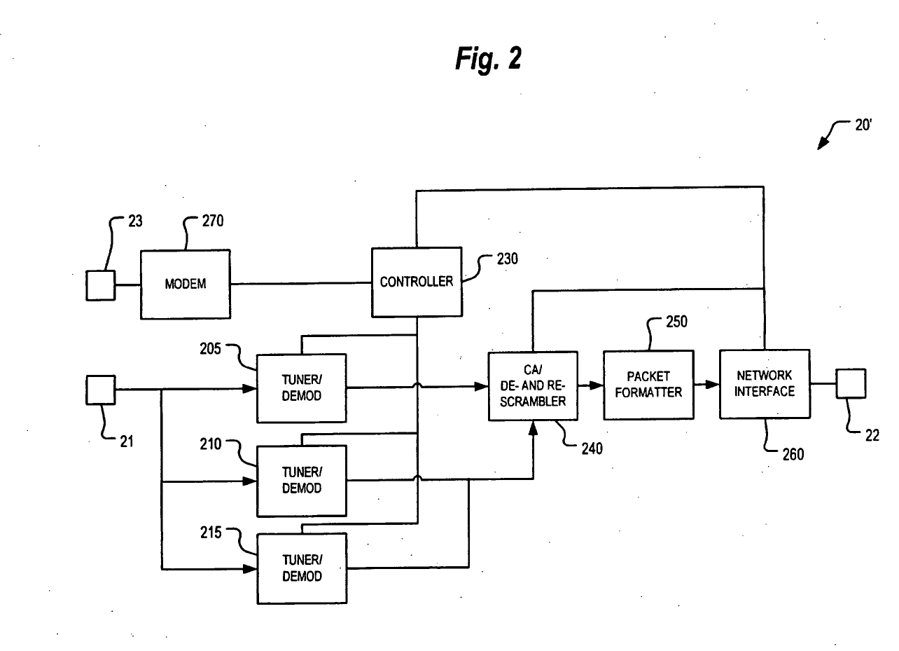

Referring now also to FIG. 2, there is shown a block-diagram of a satellite receiver 20′ suitable for use with system 100 of FIG. 1. Receiver 20′ includes a controller 230 for controlling device 20′ operation, e.g., tuners (shown as Tuner/Demod in FIG. 2) 205, 210, 215. Controller 230 communicates with other modules using a bus (not shown), such as an inter integrated circuit (IIC) bus. As used herein, the term “controller” represents various devices including, but not limited to, microprocessors, microcomputers, microcontrollers and controllers. For clarity of description, certain conventional elements associated with a satellite receiver, such as certain control signals, power signals, and/or other elements may not be shown in FIG. 2.

Each tuner 205, 210, 215 may be associated with a television/client device 30/35, 50/55, 60/65 pair. Alternatively, each tuner may be associated with a separate transponder available for tuning. Thus, the number of tuners provided may be associated with either the number of television/client device pairs in system 10, and/or the number of transponders available for tuning. Of course, statistical considerations may be applied in determining a number of tuners required, such that a one-to-one correspondence may not be necessary. In the illustrated case of FIG. 2, tuners 205, 210, 215 are respectively associated with the television/client device pairings 30/35, 50/55, 60/65. Each tuner tunes to a channel as instructed by controller 230 responsively to a request from the corresponding television/client device 30/35, 50/55, 60/65 pairing, and demodulates video signals from that channel into a demodulated video stream. The demodulated video streams are fed to a conditional access module 240 for decryption purposes before being further distributed.

CA module 240 may take the form of a collection of conventional conditional access service providing smart cards. Each smart card provides the ability to facilitate descrambling a collection of transport streams (associated with a program). As receivers are added to the distribution network, smart cards can be allocated on a one-to-one basis (one smart card, one receiver). In this process, whenever a new receiver is added to the network it is authenticated by securely collecting receiver ID information and associating this information with a specific customer account and the specific smart card. This may be accomplished by having the smart card securely “call back” to the service with sufficient information to do the association and validation. Once this is accomplished, the service transmits to the smart card sufficient secret information to enable it to support descrambling of programs for the specific receiver ID. In such a configuration, the controller may maintain a map of receiver IDs to specific smart card in order to process correctly program requests from the receivers.

Depending on the capability of the smart cards (internal memory storage, processing capability, bandwidth access) and the system service, multiple receivers and even multiple accounts can be associated with a single card. The manner of mapping may be identical to the above except that a single card can support multiple programs and accounts.

Further yet, a secure multi-program, multi-account conditional access processor can be implemented. In this case, a single conditional access processor could be used to support all, or groups, of receivers on the distribution network. The allocation and authentication process may be identical to that described above. Sufficient secure memory, processing power, and interface bandwidth may be integrated into the device to support the maximum number of receivers on the distribution network. In such a case, a field programmable gate array (FPGA) may be used with a conventional, high-speed secure processor to aggregate the conditional access functionally of the multiple smart cards. Either way, relocating CA services to the head-end serves to reduce costs and user confusion associated with CA implementing set-top boxes, and simplifies the billing function for both a user and a service provider. Receiver 20′ will be discussed as it relates to a CA module 240 incorporating multiple, conventional conditional access modules, e.g., smart cards, for non-limiting purposes of explanation only.

Receiver 20′ further includes a packet formatter 250, and network interface 260. Packet formatter 250 is preferably adapted for use with network interface 260 and network 40. The demodulated video streams, which may include MPEG-2 packets for example, are fed to packet formatter 250, which formats the delivered packets into network 40 deliverable packets, e.g., IP packets, using conventional methods. The IP packets are then transmitted through the network 40 to the client devices 35, 55, 65, respectively, using network interface 260. Packet formatter 250 may attach an IP address of the one of the devices 35 associated with the tuner 205. Like packet formatter 250, network interface 260 is preferably adapted for use with network 40 (e.g., a TCP/IP network). In the illustrated embodiment, network interface 260 is communicatively coupled to: packet formatter 250—to receive formatted packets for delivery to client devices 35, 55, 65 via network 40; CA module 240 for providing interconnectivity between CA module 240 and the client devices 35, 55, 65 via network 40; and controller 230, for providing interconnectivity between controller 230 and client devices 35, 55, 65 via network 40. The configuration and use of packet formatters and network interfaces are well known in the pertinent arts.

Receiver 20′ also includes a modulator/demodulator (MODEM) 270 suitable for communicating with the broadcast, e.g., programming, source via the callback link, e.g., a POTS or Internet connection, via port 23.

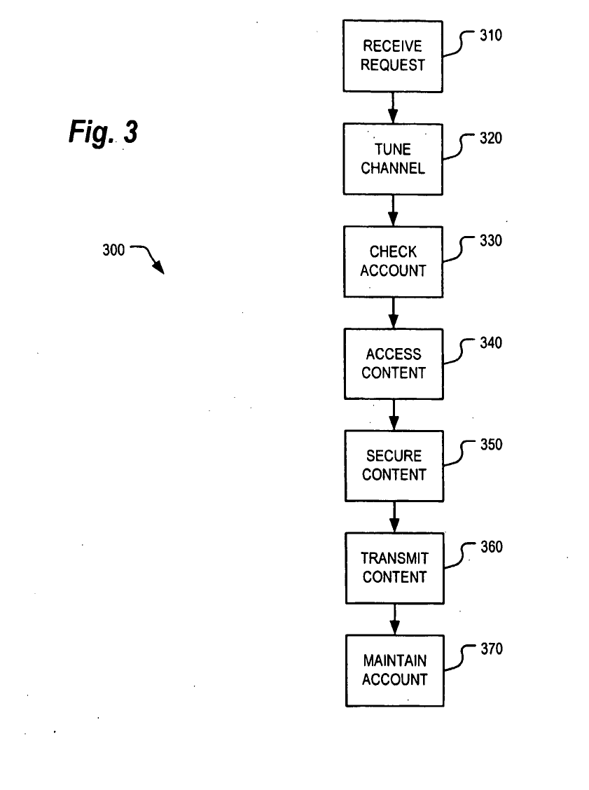

Referring now also to FIG. 3, there is shown a process flow 300 diagram according to an aspect of the present invention. Process flow 300 is suitable for use in combination with a system 100 (FIG. 1) incorporating receiver 20′ (FIG. 2). By way of non-limiting example, controller 230 receives a content request, e.g., a particular video program for viewing, from a television 30 user via conventional user interaction with associated client device 35 (process 310). That is, device 35 transmits data indicative of the user request to receiver 20′ via network 40. The request is received by receiver 20′ on port 22 using network interface 260. The request is then forwarded to controller 230. Controller 230 processes the request and instructs tuner 205, which corresponds to television/client device pairing 30/35, to tune the transponder corresponding to the requested channel and video program (process 320). Tuner 205 generates a data stream indicative of signals received via port 21 responsively to tuning the transponder corresponding to the requested content of course, the other tuners 210, 215 may simultaneously generate their own data streams indicative of other channels and video programs being tuned. Controller 230 also processes the request to confirm the requesting television/client device pairing 30/35 is authorized to access the requested content (process 330). This determination may be akin to that conventionally used by CA enabled satellite receiver set-top boxes. The request may also be forwarded to CA module 240.

If the requesting client device 35 is authorized to receive the requested content, the CA implementing smart-card of CA module 240 associated with tuner 205 and/or television/client device pairing 30/35 receives the data stream indicative of the requested content from tuner 205, and performs conventional conditional access processing on the received data stream to enable television/client device pairing 30/35 to present the content (process 340). For example, CA module 240 may access descrambling keys and descramble the data indicative content using client device 35 associated account data in a conventional manner. The accessed content may then be re-secured for transmission to the television/client device pairing 30/35 via network 40. The processed data stream is then provided to packet formatter 250 for conventional formatting, and thereafter the formatted, processed data stream is provided to network interface 260 for provision to client device 35 via network 40 (process 360). Finally, controller 230 may maintain account data associated with television/client device pairing 30/35 (process 370)—such as by updating account billing information associated with the requesting client device 35 to reflect that a content request was received and/or authorized.

By way of further, non-limiting example, a user may interact with client device 35 using a remote control and graphical user interface (GUI) in a conventional manner to request presentation of a particular program, such as a PPV event. Data indicative of the user request is received by receiver 20′ from client device 35 via network 40, port 22 and network interface 260. According to an aspect of the present invention, controller 230 processes the received request to identify and authenticate the requesting client device 35. Alternatively, CA module 240 may authenticate the requesting device 35. Either way, device 35 identification and authentication may be performed in a conventional manner, such as by checking a source address for the request, time for the request and digital signature attached to the request. According to alternative aspects of the present invention, tuner 205 may be instructed to tune a transponder corresponding to the received request either before, during or after device identification and/or authentication.

Once identified and authenticated, controller 230 may process account data corresponding or correlating to the requesting client device 35 and service provider, to confirm that an account associated with the requesting client device is authorized to receive the requested content. For example, in the case of a PPV event, controller 230 may confirm requested PPV content is authorized for delivery by checking subscription data for the account associated with the requesting device 35, and updating the subscription data to reflect the PPV event if that event has not been previously purchased and is available for purchase by the client device 35.

Thereafter, controller 230 may advise CA module 240 of the permission to access, to authorize CA module 240 to operate in conjunction with the requesting device 35 to deliver the requested content. In response, CA module 240 engages conventional conditional access process(es) to access the authorized content, e.g., accesses descrambling keys and descrambles the authorized content using account information associated with the requesting device 35. CA module 240 may communicate with the requesting device 35 via network 40 to establish one or more re-scrambling keys for frustrating un-authorized access of the content transmission from receiver 20′ to requesting device 35. For example, CA module 35 may encrypt a local scrambling key, e.g., a symmetric key, used to re-scramble the content using the key first used to authenticate the digital signature associated with the request. In such a case, only the authenticated and authorized requesting device may access the key, which may then be used to descramble the requested content upon receiving the same in a conventional manner. By way of further non-limiting explanation, a private key of a public/private key pairing corresponding to device 35 may be used by device 35 to sign the request, and access the symmetric key; while the public key of the public/private key pairing is used to authenticate device 35 and encrypt the symmetric key for transmission to device 35 by receiver 20′.

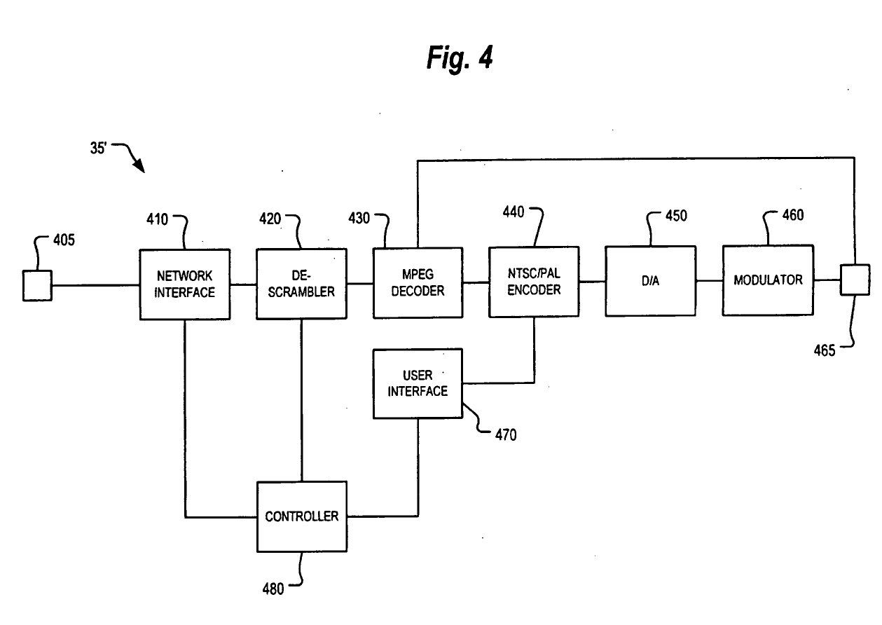

Referring now also to FIG. 4, there is shown a block diagram of a device 35′ according to an aspect of the present invention. Device 35′ is suitable for being used as any of client devices 35, 55, 65 of system 100 of FIG. 1. Device 35′ includes a port 405 suitable for being communicatively connected to network 40 and a port 465 suitable for being coupled to a television, e.g., 30 (FIG. 1). Device 35′ includes a network interface 410 akin to network interface 260 (FIG. 2). Device 35′ includes a controller 480 for controlling device 35′ operation, e.g., descrambler 420 and user interface 470. Controller 480 communicates with other modules using a bus (not shown), such as an inter integrated circuit (IIC) bus. Again, the term “controller” represents various devices including, but not limited to, microprocessors, microcomputers, microcontrollers and controllers. For clarity of description, certain conventional elements associated with receivers, such as certain control signals, power signals, and/or other elements may not be shown in FIG. 4.

Controller 480 may be used to receive scrambling keys from CA module 240 (e.g., the symmetric key) and forward it to descrambler 420 for processing received content indicative data. Descrambler 420 in-turn feeds a conventional decoder, e.g., an MPEG decoder, for decoding the received content data stream into a decoded stream. Where the associated television 30 is a digital television or other device capable of directly processing such decoded streams, the resulting signal may be directly provided via port 465. Where an analog television 30 is used, the signal may be encoded with a standard television format, such as NTSC, PAL, or SECAM using a conventional encoder 440, processed by a conventional digital to analog converter 450 and modulated for reception and presentation by television 30 using a conventional modulator 460. Optionally, graphics, text, and/or video generated by a user interface 470 responsively to controller 480 can be conventionally combined with or replace the decoded video stream before modulation for transmission to television 30.

Controller 480 may operate in conjunction with user interface 470 in a conventional manner to facilitate user operation of device 35′. For example, controller 480 and user interface 470 may cooperatively present PPV events available for purchase on a connected television, detect user selections thereof via user interaction with a remote control, and forward the selections to controller 230 of receiver 20′ in a conventional manner.

It will be apparent to those skilled in the art that modifications and variations may be made in the apparatus and process of the present invention without departing from the spirit or scope of the invention. It is intended that the present invention cover the modification and variations of this invention provided they come within the scope of the appended claims and their equivalents.

1. A method for distributing video programs in a multiple dwelling unit from a receiver device to a plurality of client devices located in the multiple dwelling unit, comprising:
receiving a plurality of video programs associated with a plurality of television channels from a signal source;
receiving a request for a particular video program associated with a particular television channel from a selected one of the plurality of client devices;
confirming that an account associated with the selected client device is authorized to receive the particular video program on the particular television channel;
descrambling the particular video program using account data associated with the selected client device upon confirmation;
re-scrambling the descrambled particular video program using a local key associated with the selected client device and transmitting the re-scrambled video program to the selected client device; and
maintaining account data associated with each of the client devices in the receiver and transmitting updated account data to the signal source.

2. The method of claim 1, wherein said receiving a plurality of video programs comprises tuning to a plurality of transponders.

3. The method of claim 1, wherein said confirming comprises authenticating the selected client device.

4. The method of claim 3, wherein said confirming further comprises correlating the account data to said selected client device.

5. The method of claim 4, wherein said confirming is further dependent upon the correlated account data.

6. The method of claim 5, wherein said maintaining comprises updating the correlated account data.

7. The method of claim 1, wherein said descrambling comprises decrypting at least one scrambling key.

8. The method of claim 7, wherein said re-scrambling comprises using at least one key distinct from said scrambling key.

9. The method of claim 1, further comprising transmitting data indicative of said at least one key distinct from said scrambling key to said selected client device.

10. An apparatus for distributing programming source subscription account based programming to a plurality of client devices located in multiple dwelling units, respectively, the apparatus comprising:
a controller communicatively coupled to said plurality of client devices and operative to receive programming requests from said client devices;
a plurality of tuners for receiving a plurality of programming channels responsively to said controller;
a conditional access module for selectively providing access to said programming channels responsively to said controller; and
a memory storing billing information associated with said client devices and a plurality of programming source subscription accounts.

11. The apparatus of claim 10, further comprising controller executable code stored in the memory, said code, when executed by the controller, operative to confirm that the account corresponding to a programming requesting client device is authorized to receive the requested programming.

12. The apparatus of claim 11, wherein the code, when executed by the controller, is operative to cause the conditional access module to descramble the requested programming.

13. The apparatus of claim 12, wherein the code, when executed by the controller, is operative to re-scramble the requested programming.

14. The apparatus of claim 13, wherein the code, when executed by the controller, is operative to transmit the re-scrambled video program to the requesting client device.

15. The apparatus of claim 11, wherein the code, when executed by the controller, is operative to maintaining the corresponding account data.

16. A method for distributing programming source subscription account based programming to a plurality of associated multiple dwelling units at a common location, comprising:
providing at least one client device in each dwelling unit;
receiving subscription based programming at a head-end at said common location;
receiving a request for a particular portion of the programming from a selected one of the client devices at the head-end;
confirming that an account associated with the selected client device is authorized to receive the particular programming at the head-end;
descrambling the particular programming using account data associated with the selected client device in response to the confirmation at the head-end;
re-scrambling the descrambled particular programming using a local key associated with the selected client device and transmitting the re-scrambled particular programming to the selected client device; and
maintaining account data associated with each of the client devices in the receiver at the head-end and transmitting updated account data to the signal source from the head-end.

17. The method of claim 16, wherein said confirming comprises authenticating the selected client device.

18. The method of claim 16, wherein said receiving said programming comprises tuning to a plurality of transponders.

19. The method of claim 16, further comprising transmitting data associated with the re-scrambling to the selected client device.

20. The method of claim 16, wherein said maintaining comprises updating the correlated account data.
